(19) United States
(12) Patent Application Publication
(10) Pub. No.: US 2026/0181514 A1
(43) Pub. Date: Jun. 25, 2026

(54) CHO That Considers AIML Functionality Applicability

(71) Applicant: InterDigital Patent Holdings, Inc., Wilmington, DE (US)

(72) Inventors: Oumer Teyeb, Montreal (CA); Dylan Watts, Montreal (CA); Yugeswar Deenoo Narayanan Thangaraj, Chalfont, PA (US); Patrick Tooher, Montreal (CA)

(73) Assignee: InterDigital Patent Holdings, Inc., Wilmington, DE (US)

(21) Appl. No.: 18/990,738

(22) Filed: Dec. 20, 2024

(51) Int. Cl. H04W 36/36; H04W 36/00; H04W 36/08

(52) U.S. Cl. CPC H04W 36/362; H04W 36/0061; H04W 36/08

(57) ABSTRACT

A wireless transmit/receive unit (WTRU), which include one or more processors, may be configured to receive a configuration to activate one or more artificial intelligence or machine learning (AI/ML) functionalities and to receive conditional handover (CHO) configurations to one or more candidate cells, and a plurality of signal level thresholds associated with the serving cell. The WTRU may be configured to compare the serving cell signal level with each of the plurality of serving cell signal level thresholds and determine applicabilities of each of the one or more AI/ML functionalities for the CHO configurations based on the comparisons between the serving cell signal level and each of the one or more serving cell signal level thresholds.

### BACKGROUND

Third generation partnership project (3GPP) has started specifying mechanisms and frameworks for using artificial intelligence/machine learning (AI/ML) based approaches both the air interface level (e.g., channel state information (CSI)-feedback enhancements (e.g., CSI compression), beam management/prediction and wireless transmit/receive unit (WTRU) positioning) and network level (e.g., network energy saving, load balancing and mobility).

### SUMMARY

A wireless transmit/receive unit (WTRU) may include one or more processors. The WTRU may be configured to receive conditional handover (CHO) configurations to one or more candidate cells. The CHO configurations to one or more candidate cells may include CHO thresholds associated with each of the one or more candidate cells. The WTRU may be configured to receive a configuration. The configuration may include a plurality of signal level ranges associated with a serving cell and a set of artificial intelligence and machine learning (AI/ML) functionalities associated with each of the plurality of signal level ranges associated with the serving cell. The WTRU may be configured to perform measurements of a signal level of the serving cell and signal levels of the one or more candidate cells. The WTRU may be configured to determine a group of the one or more candidate cells that fulfill the CHO threshold corresponding with the CHO configuration of each of the group of the one or more candidate cells. The WTRU may be configured to determine applicabilities of each of the set of AI/ML functionalities at each of the group of the one or more candidate cells. An applicability of an AI/ML functionality may be determined based on the signal level of the serving cell falling within a signal level range associated with the serving cell corresponding to the AI/ML functionality. The WTRU may select a target cell from candidate cells with one or more applicable AI/ML functionalities in the set of AI/ML functionalities. The WTRU may perform a CHO to the target cell by executing CHO configuration corresponding to the target cell.

The set of AI/ML functionalities may be an empty set. Each of the set of AI/ML functionalities may be supported by the WTRU. The set of AI/ML functionalities may include one or more AI/ML functionalities that are currently activated. The set of AI/ML functionalities may include one or more AI/ML functionalities currently applicable at the serving cell that are not activated. The set of AI/ML functionalities may include one or more AI/ML functionalities that are currently not applicable at the serving cell. The target cell may include a candidate cell with the highest signal level among the candidate cells with one or more applicable AI/ML functionalities in the set of AI/ML functionalities. The target cell may include a candidate cell with the greatest number of applicable AI/ML functionalities among the candidate cells with one or more applicable AI/ML functionalities in the set of AI/ML functionalities.

The WTRU may be further configured to send a handover completion message to the target cell.

On condition that a candidate cell is determined to fulfill the CHO threshold but the CHO to the candidate cell is not triggered, (e.g., the no triggering may be due to the one or more applicable AI/ML functionalities not being applicable at the candidate cell), the WTRU may be further configured to send an indication to a network. The indication may include the one or more applicable AI/ML functionalities that are not applicable at the candidate cell, and/or measurements of the serving and the candidate cell.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flow diagram illustrating an example procedure for signaling for enabling Artificial Intelligence and Machine Learning (AI/ML) functionality applicability determination and functionality activation.

FIG. 3 is a flow diagram illustrating an example procedure for conditional handover (CHO) configuration and execution.

### DETAILED DESCRIPTION

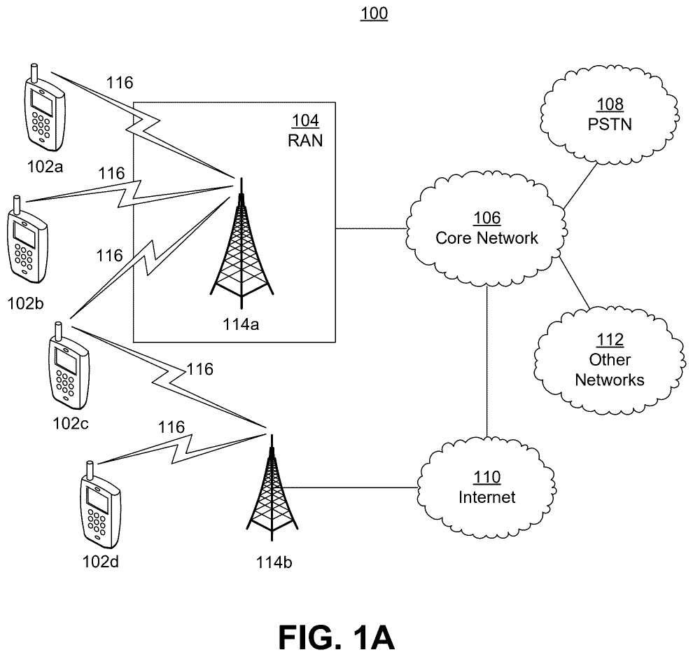

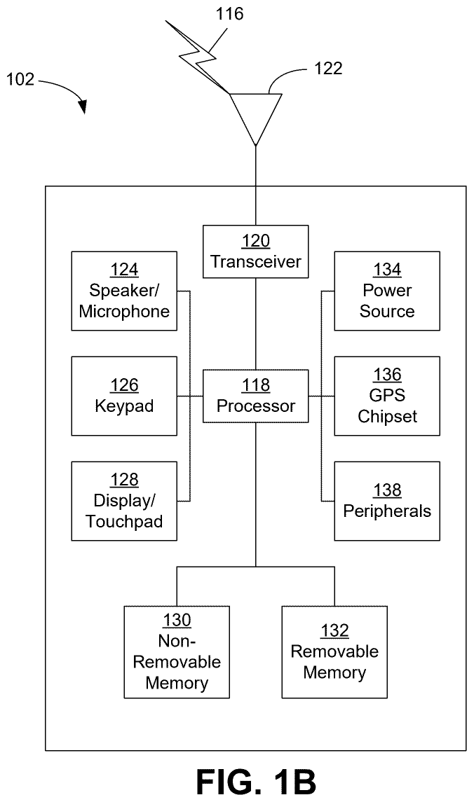

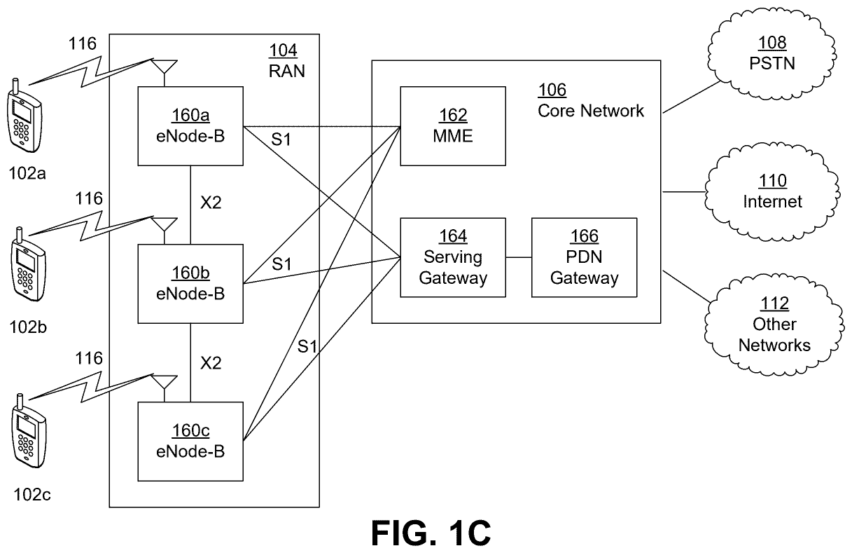

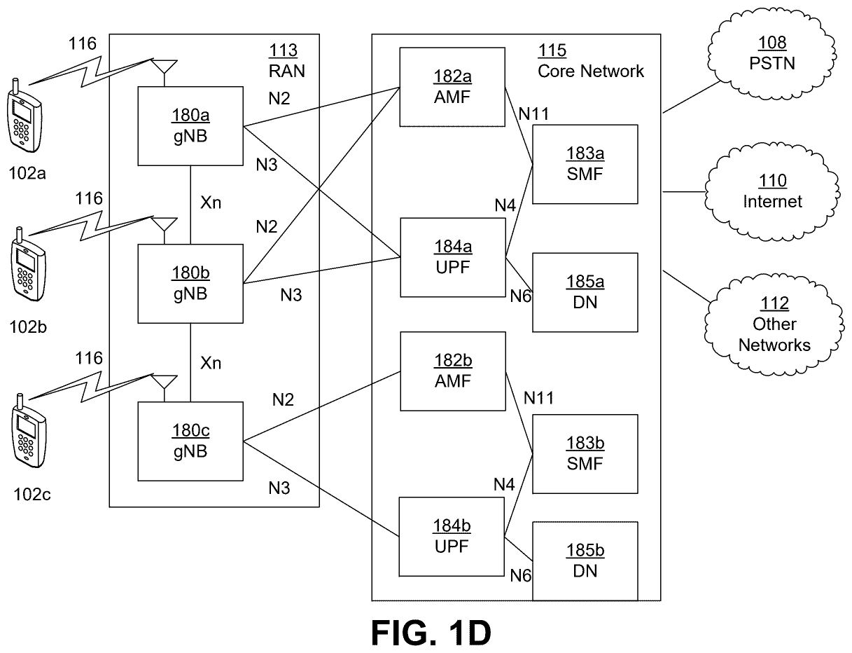

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The embodiments described herein may be agnostic to the kind of Artificial Intelligence and Machine Learning (AI/ML) model and/or technique used by the WTRU (e.g., the algorithm used, the mechanism such as neural network or what kind of neural network, depth and parameters/weights of the network, and the like), the origins of the model (e.g., WTRU vendor, operator, network vendor, and the like), and/or how and/or where the training of the model is done (e.g., the input data used for the training, where the training is performed, if the training is performed offline or online, and the like). However, it may be assumed that the model is trained based on historical observation of one or more WTRU's actual measurements in different WTRU and network conditions. For example, the different WTRU and network conditions may include conditions indicating certain time durations of the day, certain days of the week, different locations, different WTRU mobility patterns and/or speeds, different network conditions that are visible to the WTRU such as frequency and/or bandwidth, different network configurations, which may be visible to the WTRU just as a network configuration index that is provided by the network at the time of training or data collection for the training, and the like).

The terms “AI/ML” and “AIML” are used interchangeably.

The terms “data”, “measurements”, “report” and “results” are used interchangeably.

The terms “indication”, “information” and “message” are used interchangeably.

The terms “current cell”, “serving cell”, and “source cell” are used interchangeably.

The terms “target cell”, “candidate cell”, and “neighbor cell” are used interchangeably.

The terms “handover” and “cell switching” are used interchangeably.

The terms “functionality” and “procedure” are used interchangeably.

The terms “execute”, “apply” and “perform” are used interchangeably.

The terms “send recovery message” and “initiate recovery” are used interchangeably to indicate the WTRU sending the re-establishment request or the HO complete message.

The terms “legacy” and “non-AIML” are used interchangeably.

The term “supported functionality” is used to refer to AIML functionalities that the WTRU is capable of. However, this doesn't necessarily mean that the AIML functionality can be activated. For example, the WTRU may not have a model that is trained for the current WTRU or network side additional conditions. For another example, the WTRU may have a model but it is not trained, or the WTRU may not even have a model for that functionality (e.g., WTRU may just be capable of the AIML functionality from hardware and software point of view).

The term “applicable functionality” refers to functionalities where the WTRU has at least one model that is trained for the current WTRU and network side additional conditions (e.g., at least tested to work in those conditions), and as such the functionality may be activated. For example, the WTRU may use an AIML to perform inference instead of or in addition to use non AIML techniques. For example, the WTRU may use an AIML to predict signal level of serving, neighbor cells, or beams instead of (or in addition to) performing the actual measurements. The term “applicable functionality” may be used in some cases to the functionalities (e.g., only to the functionalities) where the WTRU also have the configuration for performing the inferences in addition to just having a model that is compatible to the current WTRU and network side additional conditions.

The term “activated functionality” refers to functionalities that the WTRU is already using an AIML model for inference. For example, the WTRU may be using an AIML model to predict signal levels of beams and/or cells.

The term “configured functionality” refers to functionalities where the WTRU has been configured with (e.g., at least to perform functionality applicability). Some configured functionalities may be applicable and some may not be applicable. Some of the applicable functionalities may be activated or not be activated.

The term “a target cell that enables a functionality” has the same meaning as “a functionality is applicable at the target cell”.

During normal operations, it may be assumed that an AIML function must be applicable before it can be activated. However, there may be some cases where an AIML function may be activated but not applicable. For example, the WTRU may move from one cell to another where the functionality is not applicable anymore, for example, due to a change of the network side additional condition in the new cell. If the WTRU is not configured to activate and/or deactivate functionalities autonomously, there may be some transition time where the functionality is activated while not being applicable. For example, the transition time may include time during which the WTRU informs the network the functionality is not applicable and the network deactivating the functionality for AIML operation).

The terms “inactive”, “inactivated”, “non-active”, “non-activated”, “dis-active”, and “dis-activated” are used interchangeably.

The proposed embodiments described herein may be equally applicable to any other form of prediction that doesn't use AIML (e.g. time series forecasting, interpolation methods, and the like).

The embodiments described herein may focus on the conditional handover (CHO) case. However, each of the embodiments may be applicable to conditional lower-layer triggered mobility (LTM) as well.

The WTRU may be configured not to consider AIML applicability as criteria for CHO if the serving cell signal level is below a certain configured threshold/range.

The WTRU may be configured to consider AIML applicability of currently applicable and/or activated functionalities at the target as part of the CHO criteria, in addition to radio related conditions, when the serving cell radio conditions is within a certain range.

The WTRU may be configured to consider AIML applicability of functionalities that (e.g., at the target) are not currently applicable as part of the CHO criteria, in addition to radio related conditions, when the serving cell radio conditions is above a certain value and/or range.

The WTRU may be configured to send indication to the network when a CHO is not triggered even though it has fulfilled the radio related trigger conditions (e.g., as in legacy) but has not fulfilled the AIML applicability related trigger conditions.

Mechanisms and frameworks may be specified for using AI/ML based approaches both the air interface level (e.g., channel state information (CSI)-feedback enhancements (e.g., CSI compression), beam management/prediction and WTRU positioning) and network level (e.g., network energy saving, load balancing and mobility).

AI/ML operations may be based on models (e.g., neural networks) that have been trained using a substantial amount of data under different scenarios and/or conditions. The conditions may include WTRU side conditions (e.g., speed) and/or network side conditions (e.g., antenna pattern, load, etc.). These conditions may be referred to as WTRU side additional conditions and network side additional conditions, respectively.

For a given AI/ML functionality, there may be several models. For example, each of the several models may be trained and/or suitable for different network and/or WTRU side additional conditions.

A given AI/ML model may be trained under certain WTRU and/or network side additional conditions. For example, a WTRU side condition may be the speed of the WTRU. On the other hand, network side additional conditions may be something that may be related to some network configurations/settings that the WTRU may not be aware of but may impact the performance of the model. For example, an AI/ML beam management model may perform differently if it is trained when the network was using a certain antenna pattern, beam pattern, power levels, and so on. Also, there may be aspects related to network load, which may have impact on the model performance. A model may be trained on training data selected for particular features. The model may be trained to update parameters and/or hyperparameters over multiple iterations of the training process using different training data to improve model performance to a threshold. The trained parameters and/or hyperparameters may be implemented during an inference phase of the model.

Since the WTRU doesn't necessarily need to know each of the details of the network side additional conditions (and network may also not want to expose some of these implementation), the network may hide these details by signaling to the WTRU one or more associated ID(s). For example, when data is being collected for training a model, tagging may be performed indicating under which network side additional conditions the model is being trained. When a WTRU is being configured to perform an AI/ML operation, the WTRU may be configured to check the consistency between the conditions under which the AI/ML model is trained on and current conditions (e.g., current WTRU conditions, current associated ID(s) signaled by the network indicating current network conditions/settings, etc.). The procedure of the WTRU checking if it has an AI/ML functionality that is ready to be activated (e.g., there is at least one model for the AI/ML functionality that trained/tested for current WTRU and network side additional conditions, etc.) is referred to as “applicability determination”.

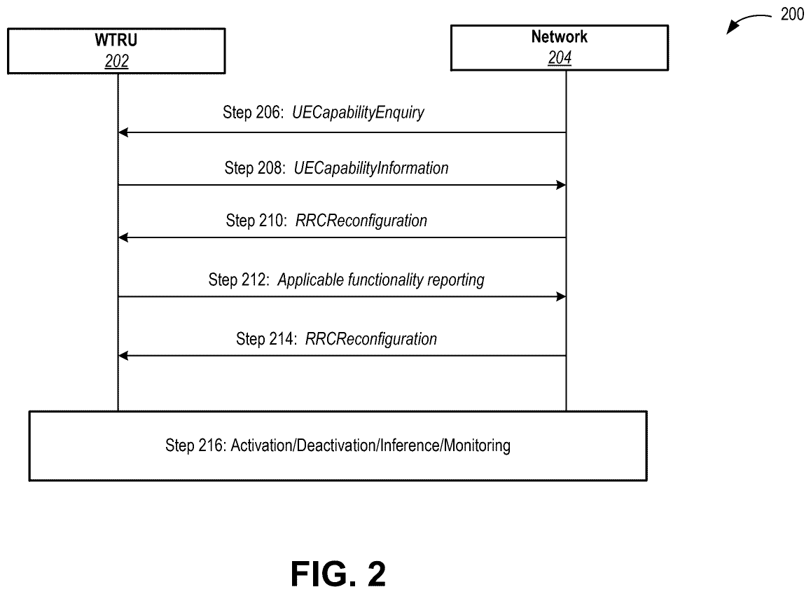

FIG. 2 describes a high-level overview of how an AI/ML functionality gets activated. In other words, FIG. 2 is a flow diagram illustrating an example procedure 200 for signaling for enabling Artificial Intelligence and Machine Learning (AI/ML) functionality applicability determination and functionality activation.

In step 206, Network 204 may send UECapabilityEnqiry message to initiate the procedure to a WTRU 202 reporting its AI/ML supported functionalities.

In step 208, the WTRU 202 may send UECapablityInformation message to network 204. The UECapablityInformation message may include supported functionalities at the WTRU side.

In step 210, the network 204 may send a radio resource control (RRC) reconfiguration message, which may contain a request for the WTRU 202 to perform the applicability determination, for example, for one or more functionalities that the WTRU 202 has indicated that it is capable of in step 206.

In step 212, the WTRU 202 may determine which AI/ML functionalities are applicable. The WTRU 202 may send an indication to the network (e.g., indications on which functionalities are applicable, and/or which functionalities are not capable). The WTRU 202 may do the applicability determination and send the applicability report immediately after the reception of the request from the network in step 210. The WTRU 202 may be configured to do the applicability reporting later proactively. In one example, the WTRU 202 may be configured to do the applicability reporting later proactively when a given AI/ML functionality becomes applicable. In another example, the WTRU 202 may be configured to do the applicability reporting later proactively due to the change of the WTRU condition (e.g., WTRU speed).

In step 214, the network 204 may configure inference configuration to the WTRU 202 if the inference configuration was not provided in step 210.

In step 216, the AI/ML functionality may be activated, deactivated, interfered, and/or monitored after step 214. In one example, the step 216 may happen along with step 214.

Conditional handover (CHO) may be implemented to reduce the likelihood of radio link failures (RLF) and handover failures (HOF).

Legacy long term evolution (LTE) and/or new radio (NR) handover may be typically triggered by measurement reports, even though there is nothing preventing the network from sending a HO command to the WTRU even without receiving a measurement report. For example, the WTRU may be configured with an A3 event that triggers a measurement report when the radio signal level/quality (reference signal received power (RSRP), reference signal received quality (RSRQ), etc.) of a neighbor cell becomes better than the current serving cell. The WTRU may monitor the serving and neighbor cells and send a measurement report when the conditions get fulfilled. When such a report is received, the network (e.g., current serving node and/or cell) may prepare the handover (HO) command and send it to the WTRU, which the WTRU executes immediately resulting in the WTRU connecting to the target cell. Basically, an RRC Reconfiguration message may include instruction and/or configuration needed to establish a connection with the target cell and continue the uplink (UL) and/or downlink (DL) communication without interruption

CHO may differ from legacy handover into the following main aspects, described herein.

Multiple handover targets may be prepared as compared to one target in legacy case. And the WTRU may not immediately execute the CHO as in the case of the legacy handover. Instead, the WTRU may be configured with triggering conditions a set of radio conditions, and the WTRU may execute the handover towards one of the targets only when the triggering conditions are fulfilled.

The CHO command may be sent when the radio conditions towards the current serving cells are still favorable, thereby reducing the two main points of failure in legacy handover. Two main points of failure in legacy handover may include risk failing to send the measurement report and the failure to receive the handover command. For example, the risk failing to send the measurement report may happen if the link quality to the current serving cell falls below acceptable levels when the measurement reports are triggered in normal handover. For another example, the failure to receive the handover command may happen if the link quality to the current serving cell falls below acceptable levels after the WTRU has sent the measurement report, but before it has received the HO command.

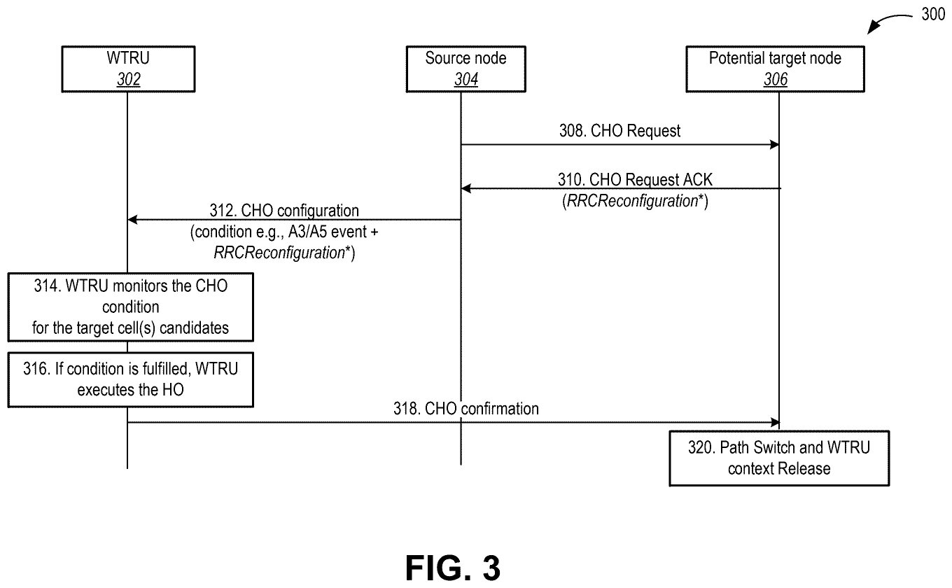

FIG. 3 is a flow diagram illustrating an example procedure 300 for conditional handover (CHO) configuration and execution. At step 308, a source node 304 may send a CHO request to a potential target node 306. The potential target node 306 may send back a CHO request acknowledgement to the source node 304 at step 310. The source node 304 may further send CHO configuration to a WTRU 302 at step 312. The WTRU 302 may monitor the CHO condition for the target cell candidates, as depicted in 314. At 316, the WTRU 302 may execute the handover if condition is fulfilled. After execution, the WTRU 302 may send a CHO confirmation to the potential target node 306 at step 318. The potential target node 306 may perform path switch and WTRU context release at 320.

Another benefit of CHO may be helping prevent unnecessary re-establishments in case of a radio link failure. For example, assuming the WTRU is configured with multiple CHO targets and the WTRU experiences an RLF before the triggering conditions with any of the targets gets fulfilled, legacy operation may have resulted in RRC re-establishment procedure that have incurred considerable interruption time for the bearers of the WTRU. However, in the case of CHO, if the WTRU, after detecting a radio link failure (RLF), ends up a cell for which it has a CHO associated with (e.g., the target cell is already prepared for it), the WTRU may execute the HO command associated with this target cell directly, instead of continuing with the full re-establishment procedure.

L1/L2 triggered mobility (LTM), where the WTRU is pre-configured with RRC reconfiguration to apply upon switching (for example, being handed over) from a source cell to a target cell, may conduct the switching and/or handover upon receiving a MAC CE (which is also referred to as an LTE cell switch command) indicating the cell switch (for example, instead of autonomous handover in the case of CHO based on the fulfillment of measurement events). LTM may offer improvements in handover latency and interruption time compared to Layer 3 based mobility.

One aspect that may improve the latency of LTM may be the possibility of performing early synchronization. Early synchronization may also be called early TA, timing advance, and/or acquisition. For example, based on L1/L2 measurements the WTRU is sending, the network may anticipate that the WTRU needs to be switched to a particular candidate cell. The WTRU may configure the WTRU to do the early timing advance (TA) acquisition (e.g., by sending a physical downlink control channel (PDCCH) order). The WTRU may send a random access (RA) preamble to the indicated candidate cell. The target, instead of sending a random access response (RAR) message that includes the TA to the WTRU, may send the TA value to the source cell. Later, if the source indeed decides the WTRU to switch to the candidate cell, it may include the TA value in the LTE cell switch command. For example, the WTRU may not need to perform RA procedure to execute the switching to the target and may directly send the HO complete message to the target. This may be referred to as random access channel (RACH)-less LTM.

Similar to the CHO case, a cell configured for LTM may be used also for recovery from RLF. For example, if the WTRU detects RLF and performs a cell selection to a cell that is already configured for LTM, the WTRU may execute this LTM configuration instead of doing the re-establishment.

Conditional LTM may also be implemented. For example, a conditional LTM may be implemented to enable the WTRU with trigger conditions to execute the HO or cell switching without the need for a reception of an LTM media access control (MAC CE).

The triggering of conditional HO may consider (e.g., only) radio signal levels of neighbor/serving cells.

In one scenario, a WTRU may be served in cell_0 and have a set of activated AI/ML functionalities (e.g., functionalities A and B). The WTRU may support other functionalities that are not activated because they were not applicable in the current cell (e.g., functionalities C and D). For example, C and D may not be applicable in the current cell because the AI/ML model for these functionalities was not trained for the current cell and/or the current WTRU conditions. The current cell may include functionalities such as the frequency layer of the current cell, the current configuration, operating parameters of the cell (also known as network slide additional condition), and the like. The WTRU conditions may include current WTRU speed.

In one scenario, the WTRU may be configured with a CHO towards two target cells, cell_1 and cell_2. Since the CHO triggering conditions consider (e.g., only) radio signal levels, a WTRU may end up being handed over to target cell_1 that has marginally better (e.g., less than a threshold better) radio conditions than target cell_2. Even though handing over to cell_2 may have enabled the WTRU to continue using functionalities A and B and/or enable the activation of functionalities C and D, handing over to cell_1 may result in the deactivation of functionalities A and B and/or functionalities C and D remaining being deactivated. This result, for example, may be due to the AI/ML models corresponding to functionalities A to D being trained for the network side additional conditions of cell_2 but not for cell_1.

The current disclosure provides embodiments describing how to enable CHO that may consider not only radio conditions but also maximize the possibility of the WTRU to use and/or activate AI/ML functionalities. For example, the current disclosure may provide how to enable CHO that will keep using activated AI/ML functionalities and/or enable the activation of deactivated and/or new functionalities).

Prioritization of CHO targets that enable activation of AI/ML functionalities as a function of the serving cell radio conditions may be described herein.

A WTRU may be configured to select a subset of CHO target cells that enable the continued operation of activated AI/ML functionalities and/or enable the activation of additional functionalities, depending on the serving cell's radio conditions.

In general, a WTRU may be configured to receive CHO configurations to one or more candidate cells, and the CHO configurations to one or more candidate cells may include CHO thresholds associated with each of the one or more candidate cells.

The WTRU may receive a configuration which includes a plurality of signal level ranges associated with a serving cell and a set of AI/ML functionalities associated with each of the plurality of signal level ranges associated with the serving cell.

The set of AI/ML functionalities may be an empty set. Each of the set of AI/ML functionalities may be supported by the WTRU. The set of AI/ML functionalities may include one or more AI/ML functionalities that are currently activated. The set of AI/ML functionalities may include one or more AI/ML functionalities currently applicable at the serving cell that are not activated. The set of AI/ML functionalities may include one or more AI/ML functionalities that are currently not applicable at the serving cell.

The WTRU may perform measurements of a signal level of the serving cell and signal levels of the one or more candidate cells. The WTRU may determine a group of the one or more candidate cells that fulfill the CHO threshold corresponding with the CHO configuration of each of the group of the one or more candidate cells.

The WTRU may determine applicabilities of each of the set of AI/ML functionalities at each of the group of the one or more candidate cells. An applicability of an AI/ML functionality may be determined based on the signal level of the serving cell falling within a signal level range associated with the serving cell corresponding to the AI/ML functionality.

The WTRU may select a target cell from candidate cells with one or more applicable AI/ML functionalities in the set of AI/ML functionalities. The target cell may include a candidate cell with the highest signal level among the candidate cells with one or more applicable AI/ML functionalities in the set of AI/ML functionalities. The target cell may include a candidate cell with the greatest number of applicable AI/ML functionalities among the candidate cells with one or more applicable AI/ML functionalities in the set of AI/ML functionalities.

The WTRU may perform a CHO to the target cell by executing CHO configuration corresponding to the target cell. The WTRU may be further configured to send a handover completion message to the target cell.

The CHO to the candidate cell may not be triggered on condition that a candidate cell is determined to fulfill the CHO threshold. This no triggering may include the one or more applicable AI/ML functionalities not being applicable at the candidate cell. Under these circumstances, the WTRU may be further configured to send an indication to a network. For example, the indication may include the one or more applicable AI/ML functionalities that are not applicable at the candidate cell, and/or measurements of the serving and the candidate cell.

In various embodiments described herein, a WTRU may receive a configuration for applicability determination of AI/ML functionalities (e.g., functionality X and functionality Y) while at serving cell A.

The WTRU may determine and send an applicability report to the network (e.g., X is applicable while Y is not applicable).

The WTRU may receive a configuration to activate one or more AI/ML functionalities (e.g., functionality X).

The WTRU may receive CHO configurations to one or more candidate cells, and the CHO configurations to one or more candidate cells may include CHO thresholds associated with each of the one or more candidate cells. The WTRU may determine candidate cell signal levels associated with each of the one or more candidate cells.

The WTRU may receive serving cell signal level for a serving cell and a plurality of serving cell signal level thresholds associated with the serving cell (e.g., threshold 1 and threshold 2). At least a second serving cell signal level threshold may be greater than a first serving cell signal level threshold in the plurality of serving cell signal level thresholds associated with the serving cell.

The WTRU may further compare the serving cell signal level for the serving cell with each of the plurality of serving cell signal level thresholds associated with the serving cell. The WTRU may determine applicabilities of each of the one or more AI/ML functionalities for the CHO configurations based on the comparisons between the serving cell signal level for the serving cell and each of the one or more serving cell signal level thresholds associated with the serving cell.

Upon determining that the serving cell signal level is lower than the first serving cell signal level threshold of the one or more serving cell signal level thresholds associated with the serving cell (e.g., threshold_1) and at least a candidate cell signal level of a candidate cell reaches a CHO threshold associated with the candidate cell, the WTRU may trigger the CHO towards the best candidate cell. For example, the best candidate cell may be the candidate cell whose signal level reaches its corresponding CHO threshold, with a highest signal level among the one or more candidate cells. The WTRU may be further configured to send a CHO confirmation to the best candidate cell

Upon determining that the serving cell signal level is greater than or equal to the first serving cell signal level threshold of the one or more serving cell signal level thresholds associated with the serving cell (e.g., threshold_1) but is lower than the second serving cell signal level threshold of the one or more serving cell signal level thresholds associated with the serving cell (e.g., threshold_2), the WTRU may receive a configuration to activate a first functionality (e.g., functionality X) of the one or more AI/ML functionalities. The WTRU may further determine the applicability of the first functionality (e.g., AI/ML functionality X) in selected candidate cells. The selected candidate cells may include the one or more candidate cells in which the first functionality is applicable for the CHO configuration. For example, the WTRU may (e.g., only) consider the selected candidate cells where the functionality X is applicable as candidate cells for CHO.

On condition that at least a candidate cell signal level of a candidate cell in the selected candidate cells reaches a CHO threshold associated with the candidate cell, the WTRU may trigger the CHO towards the best candidate cell. For example, the best candidate cell may be the candidate cell whose signal level reaches its corresponding CHO threshold, with a highest signal level among the selected candidate cells.

Upon determining that the serving cell signal level is greater than or equal to the second serving cell signal level threshold of the one or more serving cell signal level thresholds associated with the serving cell (e.g., threshold_2), the WTRU may receive configurations to activate a first functionality (e.g., functionality X) and a second functionality (e.g., functionality Y) of the one or more AI/ML functionalities.

The WTRU may determine a first applicability of the first functionality (e.g., functionality X) and a second applicability of the second functionality (e.g., functionality Y) in selected candidate cells. The selected candidate cells may include the one or more candidate cells in which both the first functionality and the second functionality are applicable for the CHO configuration. For example, the WTRU may (e.g., only) consider the selected candidate cells where both functionality X and functionality Y are applicable as candidate cells for CHO.

On condition that at least a candidate cell signal level of a candidate cell in the selected candidate cells reaches a CHO threshold associated with the candidate cell, the WTRU may trigger the CHO towards the best candidate cell. For example, the best candidate cell may be the candidate cell whose signal level reaches its corresponding CHO threshold, with a highest signal level among the selected candidate cells.

Upon determining that a CHO towards a targeted candidate cell is determined to receive CHO but was not triggered due to not meeting the AI/ML applicability criteria, the WTRU may send an indication to the network. The failing to meet AI/ML criteria may include containing one or more of a target ID, measurements, and functionalities that are not applicable to the targeted candidate cell.

Artificial intelligence may be broadly defined as the behavior exhibited by machines. Such behavior may include mimic cognitive functions to sense, reason, adapt and/or act.

Machine learning may refer to types of algorithms that solve a problem based on learning through experience (e.g., ‘data’), without explicitly being programmed (e.g., ‘configuring set of rules’). Machine learning may be considered as a subset of AI. Different machine learning paradigms may be envisioned based on the nature of data or feedback available to the learning algorithm. For example, a supervised learning approach may involve learning a function that maps input to an output based on labeled training example. Each training example may be a pair consisting of input and the corresponding output. For example, unsupervised learning approach may involve detecting patterns in the data with no pre-existing labels. For example, reinforcement learning approach may involve performing sequence of actions in an environment to maximize the cumulative reward. In some embodiments, it may be possible to apply machine learning algorithms using a combination or interpolation of the above-mentioned approaches. For example, semi-supervised learning approach may use a combination of a small amount of labeled data with a large amount of unlabeled data during training. In this regard semi-supervised learning may fall between unsupervised learning with no labeled training data and supervised learning with (e.g., only) labeled training data.

Deep learning may refer to class of machine learning algorithms that employ artificial neural networks (e.g., DNNs) which were loosely inspired from biological systems. The deep neural networks (DNNs) may be a special class of machine learning models inspired by human brain. The input in the DNNs may be linearly transformed and pass-through non-linear activation function multiple times. DNNs typically may consist of multiple layers where each layer consists of linear transformation and a given non-linear activation function. The DNNs may be trained using the training data via back-propagation algorithm. Recently, DNNs have shown state-of-the-art performance in variety of domains, e.g., speech, vision, natural language, and the like. DNNs have also shown state-of-the-art performance for various machine learning settings supervised, un-supervised, and/or semi-supervised. The term AI/ML based methods and/or processing may refer to realization of behaviors and/or conformance to requirements by learning based on data, without explicit configuration of sequence of steps of actions. Such methods may enable learning complex behaviors which might be difficult to specify and/or implement when using legacy methods.

A given AI/ML model may be trained under certain WTRU and network side additional conditions. For example, a WTRU side condition may be the speed of the WTRU. On the other hand, network side additional conditions may be something that is related to some network configurations and/or settings that the WTRU may not be aware of but may impact the performance of the model. For example, an RLF prediction model may perform differently if it is trained when the network was using a certain antenna pattern, beam pattern, power levels, and so on. Also, there may be aspects related to network load, that have impact on the model performance.

Since the WTRU doesn't necessarily need to know each of the details of the network side additional conditions and network may also not want to expose some of these implementations, the network may hide these details by signaling to the WTRU one or more associated ID(s). For example, when data is being collected for training a model, tagging may be performed indicating under which network side additional conditions the model is being trained. When a WTRU is being configured to perform the AI/ML based RLF prediction, it may be configured to check the consistency between the conditions under which the AI/ML model is trained on and current conditions (e.g., current WTRU conditions, current associated ID(s) signaled by the network indicating current network conditions and/or settings, etc.).

In the embodiments described herein, it may be assumed that the WTRU may (e.g., only) perform the AI/ML based RLF prediction if it has an AI/ML model that is applicable to the current WTRU and network side additional conditions. For example, the network may have communicated the current associated ID(s). The WTRU may have indicated that it has a model that works under the current WTRU conditions and associated ID(s), and/or based on that the network has activated the AI/ML functionality at the WTRU. In case the applicability changes while the functionality is being used, the WTRU may be configured to stop the AI/ML functionality and start using legacy procedures. For example, the legacy procedures may include WTRU informing change of applicability to the network and network deactivating the functionality, WTRU autonomously deactivating the functionality when it determines applicability has changed, and the like. The applicability change may be due to the change in WTRU side conditions. The change in WTRU side conditions may include speed changes and the WTRU has no model trained for those conditions. The change in WTRU side conditions may also include associated ID changes and WTRU has no model trained for the new associated ID. For example, the associated ID change may be due to the WTRU performing a HO to a cell that is operating under different network conditions, or the network changing some of its configurations without the WTRU performing a HO, and the like.

The term Life cycle management (LCM) may be used to describe the overall management aspects of AI/ML models. The overall management aspects of AI/ML models may include model training, functionality/model identification, model delivery/transfer, functionality/model monitoring, model update, WTRU capability, data collection, model inference operation, and/or functionality or model selection, activation, deactivation, switching, and fallback operation. The data collection may include data collections for model training, for monitoring, for inference, and the like. The functionality or model selection, activation, deactivation, switching, and fallback operation may include decision by the network (e.g., either network initiated or WTRU-initiated and requested to the network), decision by the WTRU (e.g., event-triggered as configured by the network, WTRU's decision reported to the network, or WTRU-autonomous either with WTRU's decision reported to the network or without it).

LCM may be functionality-based LCM or model-ID based LCM.

In functionality-based LCM, network may indicate activation, deactivation, fallback, and/or switching of AI/ML functionality via 3GPP signaling (e.g., RRC, MAC-CE, downlink control information (DCI)). Models may not be identified at the network, and the WTRU may perform model-level LCM. The WTRU may have one AI/ML model for the functionality, or the WTRU may have multiple AI/ML models for the functionality.

In model-ID-based LCM, models may be identified at the network, and the network and/or the WTRU may activate, deactivate, select, and/or switch individual AI/ML models via model ID.

In the functionality-based LCM, the WTRU may choose the AI/ML model to use for a certain functionality. For example, the network may decide for which functionalities the WTRU can use AI/ML based operation, and the WTRU may choose the AI/ML model to use.

In the model-ID based LCM, the network may explicitly control which particular model is used for a given AI/ML functionality. For example, the WTRU may provide details of AI/ML models and their capabilities. The network may determine which model to activate for a particular functionality.

The embodiment descriptions herein may be applicable to both model-ID based and functionality-based LCM. In other words, the embodiments may be related to how the WTRU determines whether it has a model that is applicable for the indicated associated ID(s). For example, in the case of functionality-based LCM, the WTRU may be configured and/or requested to determine if a given functionality is valid and/or applicable, and it may do the determination among each of the models it has for a given functionality and may consider the functionality applicable if at least one of the models is applicable. In another example, in the case of model-ID based LCM, the WTRU may be configured and/or requested by the network to determine whether a particular model is applicable or not.

An associated ID may be specific to a given functionality, or may be applicable and/or common to more than one (e.g., all) functionalities.

The WTRU may support several AI/ML models for a given functionality. For example, these AI/ML models may have different prediction time horizons, different prediction confidence levels, different processing requirements, etc. The AI/ML models may have been trained under/for operation in different frequencies, different cells, different location, and/or different times of day, and the like.

A given AI/ML model for a certain functionality may operate in different modes. For example, different modes may include modes with different levels of prediction confidence levels at different prediction time horizons, at different locations, at different frequencies, having different WTRU mobility pattern and/or speed, and the like.

In one example, the AI/ML models may be available at the WTRU that has already been trained. In another example, the WTRU may be provided with an untrained AI/ML model and perform the training by itself.

The AI/ML model may be available at the WTRU already trained. The WTRU may be enabled and/or configured to perform further training. For example, the further training may include trainings for different conditions such as frequencies, cells, location, and/or times of day, trainings for the same conditions as the initial training but for increasing the level of confidence and/or the prediction time horizon, trainings for different WTRU speeds, and the like.

The AI/ML model may be available at the WTRU. However, the AI/ML model may not be trained at all or be trained for certain WTRU and/or network conditions, and WTRU may be configured to train the model, for example, for the conditions that it is not trained for.

In some cases, the WTRU may require some configurations and/or inputs that it needs for performing the inference using an AI/ML model. For example, for radio signal level prediction, the WTRU may need to be configured with a certain number of beams and/or cells to measure to determine the prediction. In some cases, the WTRU may communicate the required configuration and/or input as part of the capability information. In other cases, the required configuration and/or input may be communicated to the network after capability request (e.g., based on explicit network request, if the WTRU gets configured to do AI/ML based measurement predictions, and it has determined that it is lacking the required configuration and/or input, and the like).

The WTRU may send its capability related to mobility (e.g., LTM, CHO, etc.) to the network (e.g., based on explicit request from the network, proactively by the WTRU, etc.). The capability, for example, may indicate if the WTRU supports LTM, if the WTRU supports early synchronization (based on a reception of a PDCCH order and sending of a RACH preamble), and the like.

A WTRU may indicate to the network that it is capable of AIML operations.

The granularity of the capability indication may be at a use case and/or functionality level (e.g., beam management, positioning, mobility, etc.).

The granularity of the capability indication may be at a sub use or sub functionality level (e.g., spatial beam management, WTRU assisted positioning, RRM measurement prediction, etc.)

The granularity of the capability indication may be at a model level. For example, the WTRU may indicate that it has a certain number of models for a given AIML functionality, or it may even include detailed information about each model (e.g., model identities, model capabilities, model inference configuration requirements, etc.).

The capability may be provided at a functionality level. For example, the WTRU may not explicitly indicate the number/identity of the models it is using, and may simply provide the overall capability of the one or more models for the beam prediction capability. The capability may also be provided at a model level. For example, the WTRU may provide explicit information about each model it has for the beam prediction functionality and associated capability information for each model).

The capability information may be provided autonomously by the WTRU. For example, the capability information may be provided autonomously upon connection setup/resume. The capability information may be provided autonomously upon handover. The capability information may be provided autonomously upon detecting that the WTRU has entered a new cell, region, and/or radio access technology (RAT) where the capability regarding beam prediction is different from previously reported capability. The capability information may be provided autonomously based on an explicit request from the network.

If capability information is requested from the network, the request may be a generic request (for example, in which case WTRU may provide each of its capabilities) or it can be a more granular request. For example, the WTRU may receive a request from the network it is supports beam prediction at a certain frequency layer, and the WTRU may respond with an indication that it doesn't support it, or an indication that it supports that or/and detailed information about the capability regarding prediction of beam at the frequency layer (e.g., summarized information at functionality level, detailed information for each AIML model that supported beam prediction at that frequency layer, etc.)

Applicability determination and/or reporting is described herein.

The WTRU may be configured to report the applicability of AIML functionalities.

The WTRU may be configured to report each applicable AIML functionality at the moment.

The WTRU may be configured to report each non-applicable AIML functionality at the moment.

The WTRU may be configured to report the applicability and/or non-applicability of specific AIML functionalities (e.g., a list of functionalities indicated in the applicability request).

The WTRU may be configured to monitor the applicability and/or non-applicability of AIML functionalities (e.g., each functionality, a specific list of functionalities, etc.) and report to the network when the one or more functionality become applicable (e.g., if they were non-applicable before) or become non-applicable (e.g., if they were applicable before).

Applicability determination in current/neighboring cells is described herein.

The WTRU may be configured to determine the applicability of functionalities at the current cell.

The WTRU may be configured to determine the applicability of each AIML functionality at one or more neighbor cells.

The WTRU may be configured to determine the applicability of one or more AIML functionalities (for example, list of functionalities configured by the network for applicability determination) at a neighbor and/or serving cell.

The WTRU may be configured to determine if the functionalities that are currently applicable at the serving cell are also applicable at a neighbor cell.

The WTRU may be configured to determine if the functionalities that are currently non-applicable at the serving cell are applicable at a neighbor cell.

The WTRU may be configured to determine if the functionalities that are currently activated are applicable at a neighbor cell.

The WTRU may be configured to determine if the functionalities that are currently non-activated are applicable at a neighbor cell.

The WTRU may get each of or some of the information that it needs to do the applicability determination at the serving cell in a dedicated signaling. For example, the information may include information about associated ID(s) at the serving cell, information about AIML functionalities and sub-functionalities supported at the serving cell, information about inference configuration(s) that are supported at the serving cell, and the like.

The WTRU may get each of or some of the information that it needs to do the applicability determination at the serving cell in a broadcast signaling of the serving cell (e.g., broadcast signaling of associated IDs or/and functionality/sub-functionality IDs and/or inference configuration or configuration IDs, etc.).

The WTRU may get each of or some of the information that it needs to do the applicability determination at a neighbor cell in a dedicated signaling from the serving cell (e.g., information about associated ID at the neighbor cell, information about AIML functionalities and sub-functionalities supported at the neighbor cell, information about inference configuration(s) that are supported at the neighbor cell, etc.).

The WTRU may get each of or some of the information that it needs to do the applicability determination at a neighbor cell in a broadcast signaling from the serving cell (e.g., the broadcast signaling of the serving cell may contain a list of neighboring cell, e.g., physical cell identities (PCIs) or global cell IDs, and corresponding associated IDs).

The WTRU may get each of or some of the information that it needs to do the applicability determination at a neighbor cell from the neighbor cell itself (e.g., broadcast signaling of associated IDs or/and functionality/sub-functionality IDs and/or inference configuration or configuration IDs, etc.)

The WTRU may get each of or some of the information that it needs to do the applicability determination at a neighbor/serving cell from some database/repository (e.g., a CN function/node). For example, this may be done via non-access stratum (NAS) or other control plane signaling. For example, the WTRU may indicate the global cell ID of the neighbor/serving cell and/or the functionality or sub-functionality ID, and may get as a response the corresponding associated ID or associated IDs that are supported at the neighbor cell. This may be a dynamic information that changes from time to time (e.g., depending on the network implementation).

The associated ID information about the current cell or the neighbor cell, acquired by the WTRU by any of the solutions discussed above (e.g., from the current cell, neighbor cell, another function/entity, etc.) may include a timing and/or validity information associated with it (e.g., for how long the provided associated ID(s) information can be considered as valid). That is, in that case, the WTRU may need to re-acquire the associated ID information for the current/neighbor cell when/if it needs to use it (e.g., for applicability determination).

The timing information about the associated ID may be a set of time (duration) values and corresponding associated ID(s). For example, the information may include information similar to the following examples: 12 am: 6 am→associated ID x; 6 am: 9 am→associated ID y; 9 am: 12 μm→associated ID z; etc.

Terminologies for the AIML functionalities are described herein.

For the embodiment described herein, the following terminologies may be used with reference to the variables herein: C=set of AIML functionalities that the WTRU supports (i.e., capable of); A=set of AIML functionalities that are applicable in the serving cell; X=set of AIML functionalities that are activated in the serving cell (i.e., X is a subset of A); X_1=subset of X (e.g., functionalities the network would prefer to keep activated in a target cell); B=set of AIML functionalities that are not applicable in the serving cell; B_1=subset of B (e.g., functionalities the network would prefer to be activated/applicable in a target cell); Y=set of AIML functionalities that are not activated in the serving cell (i.e., this is a super set of B, e.g., containing each of the functionalities in B and some of the functionalities in A).

Prioritization of CHO targets that enable activation of AIML functionalities as a function of the serving cell radio conditions is discussed herein.

A WTRU may be configured to select a subset of CHO target cells that enable the continued operation of activated AIML functionalities and/or enable the activation of additional functionalities, depending on the serving cell's radio conditions.

A WTRU may receive a configuration for applicability determination of AI/ML functionalities (e.g., functionality X and functionality Y) while at serving cell A.

The WTRU may determine and send an applicability report to the network (e.g., X is applicable while Y is not applicable).

The WTRU may receive a configuration to activate functionality X.

The WTRU may receive multiple CHO configurations to one or more candidate cells, and/or multiple serving cell signal level thresholds (e.g., threshold 1 and threshold 2, where threshold_1 is lower than threshold_2). Each of the one or more candidate cells may associate with a CHO threshold associated with the candidate cell.

Upon determining that the serving cell signal level is below threshold_1 and at least one of the CHO candidate cells has a signal level that fulfills the CHO threshold associated with it, the WTRU may trigger the CHO towards the best candidate cell. For example, the best candidate cell may be the candidate cell among those that fulfill their CHO thresholds that has the best signal level.

Upon determining that the serving cell signal level is greater than or equal to threshold_1 but below threshold_2, the WTRU may determine the applicability of AI/ML functionality X in the candidate cells. The WTRU may (e.g., only) consider the cells where the functionality X is applicable as candidate cells for CHO.

Upon determining that at least one of these determined candidate cells has a signal level that fulfills the CHO threshold associated with it, the WTRU may trigger the CHO towards the best candidate cell. For example, the best candidate cell may be the candidate cell among those that fulfill their CHO thresholds that has the best signal level.

Upon determining that the serving cell signal level is greater than or equal to threshold_2, the WTRU may determine the applicability of AI/ML functionalities X and Y in the candidate cells, and (e.g., only) consider the cells where both functionality X and functionality Y are applicable as candidate cells for CHO.

Upon determining that at least one of these determined candidate cells has a signal level that fulfills the CHO threshold associated with it, the WTRU may trigger the CHO towards the best candidate cell. For example, the best candidate cell may be the candidate cell among those that fulfill their CHO thresholds that has the best signal level.

Upon determining that a CHO towards a target was fulfilled (e.g., from radio conditions point of view) but was not triggered due to not meeting the AI/ML applicability criteria, the WTRU may send an indication to the network. The indication may contain target ID, measurements, functionalities that are not applicable at the target, and the like.

Embodiments are described herein for implementation of AIML functionalities that are currently applicable and serving/target cell radio conditions.

The WTRU may be configured to consider the radio signal level of the serving and/or target cell and the applicability of the functionalities (e.g., currently applicable functionalities) at a target cell, to determine whether to trigger a CHO to that target or not.

The radio conditions described herein may include additional radio conditions than the CHO trigger conditions. The assumption here may be that a CHO target still must satisfy the legacy radio conditions (e.g., the CHO target may be better than the serving cell by more than a certain configured threshold before the CHO towards it may be triggered and/or executed). The term CHO radio conditions may be used to refer to the legacy CHO thresholds, unless otherwise specified.

The WTRU may be configured with a first radio signal level threshold of the serving cell (e.g., threshold 1). If the serving cell signal level is below this threshold, the WTRU may not take any AIML related considerations for the CHO. In other words, the CHO may be treated like a legacy CHO, and CHO to the target may be fulfilled whenever the CHO trigger conditions are fulfilled towards that target (e.g., target cell better than serving cell by more than the CHO threshold), the WTRU may trigger the CHO to that target.

The WTRU may be configured with a second radio signal level threshold of the serving cell (e.g., threshold 2). If the serving cell signal level is greater than or equal to the first threshold but below the second threshold, the WTRU may (e.g., only) consider the CHO targets where the AIML functionalities in set X (i.e., AIML functionalities that are currently activated in the serving cell) are also applicable in the target cell.

In one variant of the previous embodiment described herein, only CHO targets where each of the functionalities in set X are applicable may be considered.

In one variant of the previous embodiment described herein, CHO target where at least a certain configured percentage/number of AIML functionalities in set X are applicable may be considered.

In one variant of the previous embodiment described herein, the WTRU may be configured with a certain preferred list functionalities within set X (e.g., a list of subset of functionalities of set X, set X_1), and the WTRU may consider (e.g., only) the CHO target where each of the functionalities within set X_1 are also applicable.

In one variant of the previous embodiment described herein, CHO targets where at least a certain configured percentage/number of AIML functionalities within this preferred subset of the currently activated functionalities may be considered.

A combination of the above may also be possible. For example, the WTRU may be configured to consider (e.g., only) CHO targets where each of the functionalities in set X_1 and at least a certain number and/or percentage of the functionalities in set X that are not within the preferred subset (for example, in the set that is the difference between set X and set X_1) are applicable.

A variation of the above embodiment described herein may also be considered: instead of just activated functionalities, the WTRU may consider each of currently applicable functionalities at the serving cell. For example, the WTRU may be configured to consider (e.g., only) CHO target where each of or a certain configured number and/or percentage of the currently applicable functionalities may also be applicable.

The WTRU may also be configured with a preferred sub-set of the applicable functionalities and determine the applicability of those functionalities in the target cells to determine whether a target cell should be considered for a CHO.

An embodiment described herein may also be envisioned where the WTRU considers the applicability of the functionalities that are currently applicable in the current cell but not be activated or a subset of preferred functionalities within this set, in a way similar to each of the embodiments described above.

The WTRU may be configured to consider each of the above in parallel. For example, a first threshold1/2 value that is associated with each activated functionality, a second threshold1/2 values that is associated with the preferred functionalities within the activated functionalities, a third threshold1/2 values that is associated with each applicable functionality that are not activated, a fourth threshold1/2 values that is associated with the preferred applicable functionalities that are not activated, and the like, may be considered in parallel.

A variation of each of the above embodiments may be implemented where the WTRU considers the signal level of the CHO target cells in addition or instead of the serving cell's radio conditions.

In one example, the WTRU may be configured to not consider applicability of the applicable, activated, or preferred AIML functionalities in CHO target evaluation, and/or determination if the target cell signal level is above a certain threshold (e.g., absolute threshold, better than the serving cell by more than a certain threshold, etc.). In other words, the WTRU may trigger a CHO of a CHO candidate whether some of the criteria discussed above regarding the currently applicable, activated, or preferred functionalities are fulfilled or not.

A combination of each of the above-described solutions may also be possible. In one example, the WTRU may be configured to consider both serving cell radio conditions and target cell radio conditions to determine whether it should take AIML applicability of the currently applicable, activated, or preferred functionalities in the target cell. In another example, the WTRU may be configured to consider (e.g., only) serving cell radio conditions for some of the AIML functionalities and for others consider target cell radio conditions. For example, for certain functionalities (e.g., preferred functionalities among the applicable, or activated functionalities), the WTRU may (e.g., only) consider their applicability in the target as criteria for CHO if the serving cell conditions are better than a certain threshold. For other functionalities (e.g., currently activated functionalities), the WTRU may (e.g., only) consider their applicability in the target as criteria for the CHO if the target cell conditions are worse than a certain threshold. In other words, if the serving cell conditions are very good, the WTRU may wait to do the CHO only to cells that enable the activation of the preferred functionalities. The WTRU may prioritize CHO to a target that does not have excellent signal levels if it ensures that currently activated functionalities remain active.

The WTRU may be configured to consider the radio signal level of the serving and/or target cell and the applicability of the currently non-applicable functionalities at a target cell, to determine whether to trigger a CHO to that target or not.

The WTRU may be configured with a third radio signal level threshold of the serving cell (e.g., threshold 3, which may be the same or different than the threshold 2 discussed above). If the serving cell signal level is above this threshold, the WTRU may (e.g., only) consider the CHO targets where the AIML functionalities in set B (for example, AIML functionalities that are currently not applicable in the serving cell) are applicable in the target cell. In other words, the serving cell's conditions may be excellent, and a CHO towards a target cell may not be triggered (for example, even if the legacy like CHO trigger conditions are fulfilled) unless the target further ensures that the functionalities that are currently not applicable in the serving cell will become applicable.

In one variant of the previous embodiment described herein, CHO target where at least a certain configured percentage/number of the functionalities in set B (for example, currently non-applicable AIML functionalities) become applicable may be considered.

In one variant of the previous embodiment described herein, the WTRU may be configured with a certain preferred list functionalities within set B (e.g., a list of subset of functionalities of set B, set B_1), and the WTRU may consider (e.g., only) the CHO targets where each of the functionalities within set B_1 are applicable.

In one variant of the previous embodiment described herein, CHO targets where at least a certain configured percentage and/or number of AIML functionalities within this preferred subset of the currently non-applicable functionalities may be considered.

A combination of the above-described embodiments may also be possible. For example, the WTRU may be configured to consider (e.g., only) CHO targets where each of the functionalities in set B_1 and at least a certain number/percentage of the functionalities in set B that are not within the preferred subset (for example, in the set that is the difference between set B and set B_1) are applicable.

The WTRU may be configured to consider each of the above in parallel. For example, a first threshold3 value that is associated with each currently non-applicable functionality, a second threshold3 values that is associated with the preferred functionalities within the currently non-applicable functionalities, and the like, may be considered in parallel.

A variation of each of the above embodiments may be envisioned where the WTRU considers the signal level of the CHO target cells in addition (or instead of) the serving cell's radio conditions.

In one example described herein, the WTRU may be configured to not consider applicability of the currently non-applicable AIML functionalities and/or a preferred subset of the currently non-applicable AIML functionalities in CHO target evaluation and/or determination if the target cell signal level is above a certain threshold (e.g., absolute threshold, better than the serving cell by more than a certain threshold, etc.). In other words, the WTRU may trigger a CHO of a candidate whether some of the criteria discussed above regarding the currently non-applicable or a subset among these non-applicable functionalities are fulfilled or not.

A combination of the above-mentioned solutions (e.g., all the above-mentioned solutions) may be possible. For example, the WTRU may be configured to consider both serving cell radio conditions and target cell radio conditions to determine whether it should take AIML applicability of the currently non-applicable functionalities or a preferred sub-set of these. For another example, the WTRU may be configured to consider (e.g., only) serving cell radio conditions for some of the AIML functionalities. For others, the WTRU may be configured to consider target cell radio conditions. For example, for certain functionalities such as preferred functionalities among those which are not applicable at the moment, the WTRU may be configured to (e.g., only) consider their applicability in the target as criteria for CHO if the serving cell conditions are better than a certain threshold. For other functionalities, such as non-applicable functionalities that are not in the preferred list, the WTRU may be configured to (e.g., only) consider their applicability in the target as criteria for the CHO if the target cell conditions are worse than a certain threshold. In other words, if the serving cell conditions are very good, the WTRU may wait to do the CHO only to cells that enable the activation of the preferred functionalities among the currently non-applicable ones. The WTRU may prioritize CHO to a target that may not have excellent signal levels if it ensures that even the preferred functionalities among the non-prioritized one can be activated and/or enabled at the target.

When to perform AIML applicability determination is described herein.

The WTRU may be configured to perform the determination of the applicability of AIML functionalities (e.g., functionalities in set C, A, B, X, B_1, X_1, Y, etc. described above) at the CHO target cells in a periodic manner (e.g., at a configured periodicity). The periodicity may be the same for each of the different set of functionalities or may be different from one set to another. For example, the WTRU may be configured to determine the applicability of the currently activated functionalities more frequently than the currently non-applicable functionalities. The periodicity may be agnostic to the CHO target, or different periodicities may be associated with different targets.

The WTRU may be configured to perform the determination of the applicability of AIML functionalities of the one or more set, list, or group of functionalities at a CHO target cell when it detects that the WTRU side additional condition (e.g., WTRU speed) has changed. For example, due to a change of the WTRU side additional condition, a certain AIML function that was applicable at the neighbor may become non-applicable or vice versa.

The WTRU may be configured to perform the determination of the applicability of AIML functionalities of the one or more set, list, or group of functionalities at a CHO target cell when it detects that the network side additional condition (e.g., associated ID) has changed. For example, due to a change of the current network side additional condition (e.g., associated ID), a certain AIML function that was applicable at the neighbor may become non-applicable or vice versa.

The WTRU may perform the determination of the applicability of AIML functionalities of the one or more set, list, or group of functionalities discussed above only if certain radio conditions are fulfilled. For example, if the WTRU was configured to not consider AIML applicability as criteria if the serving cell's signal level is below a certain threshold (for example, priority here is to avoid RLF/HOF rather than optimize AIML operation), the WTRU may not do the checking and/or determination of AIML functionality at a target cell. For example, if periodic checking was configured as above, the WTRU may pause the applicability determination at the target until the signal level of the serving cell becomes above the configured threshold for starting to consider AIML based criteria for the CHO).

Indications from the WTRU are described herein.

If the CHO target has fulfilled the CHO trigger conditions (e.g., legacy CHO trigger conditions), but the WTRU didn't trigger the CHO due to the one or more embodiments discussed above that consider the applicability of the one or more of the set and/or group of AIML functionalities discussed above, the WTRU may be further configured to send an indication to the network. For example, the indication may indicate that a CHO target is ready from legacy perspective, but not ready from AIML perspective.

This indication may contain information about the concerned target. For example, information about the concerned target may include target cell identity (e.g., PCI, CGI, or local cell ID), associated measurement or measurement reporting configuration ID, etc.

This indication may contain current radio measurements. The current radio measurements may include measurements of serving cell, measurements concerning target cell that has fulfilled the legacy CHO trigger condition, measurements of other CHO targets, measurements of other neighbor cells that are not configured for CHO, and the like. The measurement may be filtered to include (e.g., only) cells that have signal levels above the current serving cell or better than the current serving cell by more than a certain threshold, for example, to reduce the size of the measurement report, as it is less likely for the network to decide to handover the WTRU to a cell with worse radio conditions than the serving cell, unless for load balancing purposes.

This indication may contain detailed information such as the AIML functionalities that are not applicable at the target cell that led to the decision not to trigger the CHO.

The WTRU may receive a response message from the network to this indication, which may instruct the WTRU to execute the CHO anyways.

If the WTRU has prioritized a CHO target that has worse signal level than another CHO candidate (for example, due to the consideration of the applicability of AIML functionalities, according to any of the embodiments above), the WTRU may be further configured to indicate to the network (e.g., in the HO complete message or a subsequent message after that) about this decision and may contain extra information (e.g., identity of the target cell or cells that were not selected despite having better radio conditions than the selected target cell, the signal levels of these cells, the serving cell and other neighboring cells, etc.)

Embodiments are described herein for applicability determination as secondary criteria to choose among multiple targets that fulfill CHO radio conditions.

In legacy CHO, if more than one CHO target fulfills the radio conditions (e.g., both target cell A and B have signal level better than the threshold associated with the corresponding CHO configurations), the WTRU may select the target that has the best radio conditions.

The WTRU may be configured to do the CHO determination as in legacy and use AIML based considerations (e.g., only) to differentiate among target cells that currently fulfill the CHO trigger and/or radio conditions.

In one variation of the above embodiment described herein, the WTRU may be configured to select the target, among those that fulfill their CHO trigger conditions, that enables the most number of AIML functionalities.

In one variant of the above embodiment described herein, the WTRU may be configured to select the target where the greatest number of the currently activated functionalities can remain activated. In other words, the greatest number of the currently activated functionalities may also be applicable at the target.

In one variant of the above embodiment described herein, the WTRU may be configured to select the target where the greatest number of the currently applicable functionalities can remain applicable.

In one variant of the above embodiment described herein, the WTRU may be configured to select the target where the greatest number of the currently non-applicable functionalities can become applicable.

In one variant of the above embodiment described herein, the WTRU may be configured to select the target where the greatest number of the preferred functionalities (e.g., among the activated, among the non-applicable, etc.) are applicable.

An embodiment may also be envisioned where the WTRU is configured with an explicit list and/or groups of certain functionalities (e.g., which may be a mixture of currently applicable and non-applicable, activated and non-activated, etc.), whose applicability that it must determine in a target cell to determine whether the target cell should be considered for a CHO or not in a way similar to any of the embodiments above. (e.g., only consider target cells where each of the functionalities or a certain number/percentage of the functionalities within this list are also applicable).

If there are more than one target cells that fulfill the conditions discussed according to any of the embodiments above, the WTRU may be configured to choose the cell that has the strongest signal level.

If there are more than one target cells that fulfill the conditions discussed according to any of the embodiments above, the WTRU may be configured to choose the cell that maximizes the number of applicable AIML functionalities (e.g., among the current currently applicable, activate, non-activated, non-applicable, and/or preferred, etc.).

If there are more than one target cell that fulfill the conditions discussed according to any of the embodiments above, the WTRU may be configured to choose the cell that minimizes the number of deactivation of the functionalities that were currently activated (e.g., among each of the activated ones, a sub set of preferred ones from the activated ones, etc.).

If there are more than one target cell that fulfill the conditions discussed according to any of the embodiments above, the WTRU may be configured to choose the cell that minimizes the number of functionalities that are not applicable in the target but were applicable at the serving cell (e.g., among each of the applicable ones, a subset of preferred ones from the applicable ones, etc.).

The WTRU may be configured with multiple list and/or group of AIML functionalities, each with associated priority, and the WTRU may choose the target cell that makes the greatest number of or percentage of the higher priority functionalities applicable.

The WTRU may be configured with an essential list of AIML functionalities, and the WTRU may be configured to execute a CHO to a target only if the target cell enables these AIML functionalities.

The conditions, criteria, and/or thresholds discussed above regarding the applicable, activated, or preferred functionalities may be common to each of CHO targets, or it may be configured separately for each CHO target.

1. A wireless transmit/receive unit (WTRU) comprising a processor configured to:
receive conditional handover (CHO) configurations to one or more candidate cells, wherein the CHO configurations to one or more candidate cells comprises a CHO threshold associated with a first candidate cell of the one or more candidate cells;
receive a first signal level range associated with a serving cell and a first artificial intelligence and machine learning (AI/ML) functionality associated with the first signal level range associated with the serving cell, wherein the first signal level range is between a received first serving cell signal level threshold and a received second serving cell signal level threshold;
perform measurements of a signal level of the serving cell and a first signal level for the first candidate cell;
determine that the first candidate cell fulfills the CHO threshold corresponding with the CHO configurations;
determine applicability of the first AI/ML functionality at the first candidate cell, wherein the applicability of the first AI/ML functionality is determined based on the first signal level falling within the first signal level range associated with the serving cell corresponding to the first AI/ML functionality;
select a first target cell from candidate cells for which the first AI/ML functionality is applicable; and
perform a first CHO to the first target cell by executing a first CHO configuration corresponding to the first target cell, wherein the CHO configurations comprise the first CHO configuration.

2. (canceled)

3. The WTRU of claim 1, wherein the first AI/ML functionality is supported by the WTRU.

4. The WTRU of claim 1, wherein the first AI/ML functionality is currently activated.

5. The WTRU of claim 1, wherein the first AI/ML functionality is currently applicable at the serving cell for which the first AI/ML functionality is not activated.

6. The WTRU of claim 1, wherein the first AI/ML functionality is currently not applicable at the serving cell.

7. The WTRU of claim 1, wherein the first target cell comprises a candidate cell with a highest signal level among the candidate cells for which the first AI/ML functionality is applicable.

8. (canceled)

9. The WTRU of claim 1, wherein the processor is further configured to send a handover completion message to the first target cell.

10. The WTRU of claim 1, wherein the processor is further configured to send an indication to a network based on a determination that a candidate cell fulfills the CHO threshold and that the first AI/ML functionality is not applicable.

11. The WTRU of claim 10, wherein the indication comprises the first AI/ML functionality that is not applicable at the candidate cell, and measurements of the serving cell and the candidate cell.

12. A method comprising:
receiving conditional handover (CHO) configurations to one or more candidate cells, wherein the CHO configurations to one or more candidate cells comprises a CHO threshold associated with a first candidate cell of the one or more candidate cells;
receiving a first signal level range associated with a serving cell and a first artificial intelligence and machine learning (AI/ML) functionality associated with the first signal level range associated with the serving cell, wherein the first signal level range is between a received first serving cell signal level threshold and a received second serving cell signal level threshold;
performing measurements of a signal level of the serving cell and a first signal level for the first candidate cell;
determining that the first candidate cell fulfills the CHO threshold corresponding with the CHO configurations;
determining applicability of the first AI/ML functionality at the first candidate cell, wherein the applicability of the first AI/ML functionality is determined based on the first signal level falling within the first signal level range associated with the serving cell corresponding to the first AI/ML functionality;
selecting a first target cell from candidate cells for which the first AI/ML functionality is applicable; and
performing a first CHO to the first target cell by executing a first CHO configuration corresponding to the first target cell, wherein the CHO configurations comprise the first CHO configuration.

13. (canceled)

14. The method of claim 12, wherein the first AI/ML functionality is supported by a wireless transmit/receive unit (WTRU).

15. The method of claim 12, wherein the first AI/ML functionality is currently activated.

16. The method of claim 12, wherein the first AI/ML functionality is currently applicable at the serving cell for which the first AI/ML functionality is not activated.

17. The method of claim 12, wherein the first AI/ML functionality is currently not applicable at the serving cell.

18. The method of claim 12, wherein the first target cell comprises a candidate cell with a highest signal level among the candidate cells for which the first AI/ML functionality is applicable.

19. (canceled)

20. The method of claim 12, further comprising:
sending a handover completion message to the first target cell.

21. The WTRU of claim 1, wherein the CHO threshold is further associated with a second candidate cell of the one or more candidate cells;
wherein the processor is further configured to:
receive a second signal level range associated with the serving cell and a second AI/ML functionality associated with the second signal level range associated with the serving cell, wherein the second signal level range is between the received second serving cell signal level threshold and a received third serving cell signal level threshold;
perform measurements of a second signal level for the second candidate cell; and
determine that the second candidate cell fulfills the CHO threshold corresponding with the CHO configurations.

22. The WTRU of claim 21, wherein the processor is further configured to:
determine applicability of the first AI/ML functionality at the second candidate cell, wherein the applicability of the first AI/ML functionality is determined based on the second signal level falling within the first signal level range associated with the serving cell corresponding to the first AI/ML functionality; and
determine applicability of the second AI/ML functionality at the second candidate cell, wherein the applicability of the second AI/ML functionality is determined based on the second signal level falling within the second signal level range associated with the serving cell corresponding to the second AI/ML functionality.

23. The WTRU of claim 22, wherein the processor is further configured to:
select a second target cell from candidate cells for which both the first AI/ML functionality and the second AI/ML functionality are applicable; and
perform a second CHO to the second target cell by executing a second CHO configuration corresponding to the second target cell, wherein the CHO configurations comprise the second CHO configuration.

24. The method of claim 12, further comprising:
sending an indication to a network based on a determination that a candidate cell fulfills the CHO threshold and that the first AI/ML functionality is not applicable.
